(19) United States
(12) Patent Application Publication
(10) Pub. No.: US 2009/0033474 A1
(43) Pub. Date: Feb. 5, 2009

(54) Car door opening early-warning system

(75) Inventor: Tai-Liang Chen, Kaohsiung City (TW)

Correspondence Address: REED SMITH LLP, Suite 1400, 3110 Fairview Park Drive, Falls Church, VA, 22042, US

(73) Assignee: I-Shou University

(21) Appl. No.: 11/882,552

(22) Filed: Aug. 2, 2007

(51) Int. Cl. B60Q 1/00; B60Q 5/00

(52) U.S. Cl. 340/425.5

(57) ABSTRACT

A car door opening early-warning system, which is adapted to a vehicle having a plurality of door locks and an electric module that is used to generate an actuation power, is provided. The early-warning system includes a plurality of interlocking devices and at least one warning device. The interlocking devices are disposed on the corresponding door locks, and are connected to the warning device and the electric module. The warning device is disposed on the vehicle, and when the door locks are unlocked, the interlocking devices are actuated to conduct the actuation power to the warning device, such that the warning device is actuated to send a warning signal.

### BACKGROUND OF THE INVENTION

1. Field of the Invention

The present invention relates to an early-warning system, and more particularly to a car door opening early-warning system which emits a warning signal when a door lock of the vehicle is unlocked.

2. Description of Related Art

In current society, transportation vehicles traveling at fast speed are widely used in many industry sectors for shortening operation flow, no matter accelerating the delivery of goods and products or reducing the travel time of people, and among others power vehicles moving on land are most commonly seen. However, with the increase of vehicles, traffic jams often occur, which leads to many dangerous situations. For example, it is dangerous for passengers to open the door and get off the car when the car is parked on the road side.

Generally speaking, passengers would view the coming vehicles through the rear view mirrors or direction mirrors, or directly with eyes, and then open the door to get off the car after predicting that there is a safe distance between the coming cars and his car. However, the rear view mirrors or the direction mirrors have viewing ranges, and the driver cannot view the cars beyond the viewing ranges of the rear view mirrors or the direction mirrors. Moreover, the viewing ranges of passengers inside the car may have dead angle in some extent due to the limitation of scale of the car and the positions of the door windows. If the passengers get off the car in haste, he/she is very likely to be hit by the coming vehicles, which causes a car accident and serious injuries to the driver or passengers.

Therefore, in order to avoid such situation, a warning lamp is generally disposed at the rear end of the vehicle, and an interlocking device is disposed in the handle of the door. When the door handle is pulled, the warning light is actuated at the same time, so as to inform the coming vehicle that passengers in this vehicle want to get off the vehicle. However, people usually moves out of the vehicle simultaneously when pulling the door handle to open the door, and the door is pushed open to a certain angle after pulling the door handle, such that the coming vehicle is very likely to hit the passengers getting off the vehicle or the door. Therefore, it is quite probable to incur a car accident.

### SUMMARY OF THE INVENTION

Accordingly, the present invention is directed to providing a car door opening early-warning system, which improves the convenience for passengers in using the vehicle, and emits a warning signal to alert the coming vehicle in advance before the passenger gets off, thereby enhancing traffic safety and reducing the probability of car accident.

The present invention provides a car door opening early-warning system adapted to a vehicle having a plurality of door locks and an electric module that is used to generate an actuation power. The early-warning system includes a plurality of interlocking devices and at least one warning device. The warning device is disposed on the vehicle, usually disposed at front end or rear end of the vehicle at the position corresponding to the door locks. The interlocking devices are disposed on the door locks, and are electrically connected to the electric module and the warning device. When any door lock is released from a locked state, the interlocking device is actuated simultaneously to conduct an actuation power to the warning device, and thus the warning device emits a warning signal to inform the coming vehicles.

The present invention can be further improved as follows. The warning device is a light module and is disposed at the front end or rear end of the vehicle. Or, the warning device can be an audio module disposed on the vehicle and connected to the interlocking devices. Or, a plurality of direction indicators of the vehicle is connected to the interlocking devices to directly replace the light module. The warning signal is a warning light or a warning sound emitted by the light module, the audio module, or the direction indicators after receiving the actuation power.

The present invention provides a car door opening early-warning system, which has the following advantages superior to the prior art, and has the following significantly improved effects.

(1) The warning light and warning sound are emitted when unlocking the door locks, so as to alert the coming vehicles in time that passengers in this vehicle are going to get off, thereby avoiding the car accident caused by the dead angle of vision of the passengers when opening the door.

(2) The warning light and warning sound are sent out when unlocking the door locks, and only the door locks are unlocked but the door is not opened yet, so as to alert the coming vehicle in time that passengers in this vehicle are going to get off, thereby avoiding car accident caused by the passengers when opening the door in haste.

In order to make the aforementioned and other objects, features and advantages of the present invention comprehensible, preferred embodiments accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a system according to a first embodiment of the present invention;

FIG. 2 is an arrangement view of devices according to the first embodiment of the present invention;

FIG. 3A is an actuation view of a left warning light according to the first embodiment of the present invention;

FIG. 3B is an actuation view of a right warning light according to the first embodiment of the present invention;

FIG. 4A is a schematic view of a system according to a second embodiment of the present invention; and

FIG. 4B is an arrangement view of devices according to the second embodiment of the present invention.

### DESCRIPTION OF EMBODIMENTS

The objectives, construction features, and functions of the present invention can be further understood through the detailed description with reference to the related embodiments and drawings.

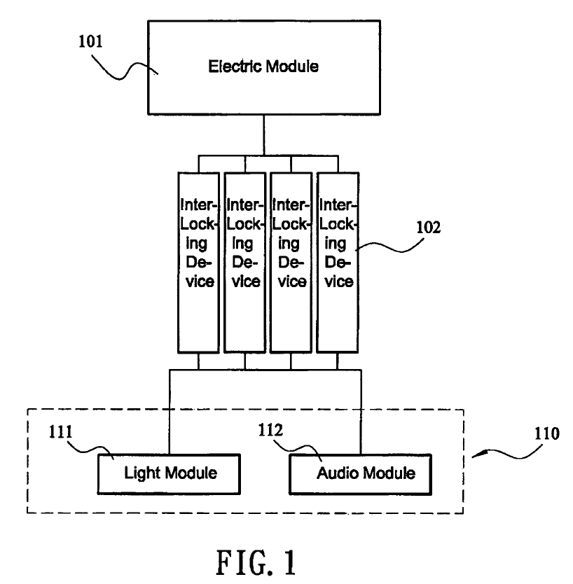

Referring to FIG. 1, a schematic view of a system according to a first embodiment of the present invention is shown. The system includes a plurality of interlocking devices 102, an electric module 101, and a warning device A 110. The warning device A 110 includes a light module 111 and an audio module 112. The electric module 101 provides an actuation power. Meanwhile, the interlocking devices 102 are connected to the electric module 101, the audio module 112, and the light module 111, and the interlocking devices 102 are respectively disposed on a plurality of door locks (not shown) of a vehicle 100. When the door locks are unlocked, i.e., released from a locked state, the interlocking devices 102 are actuated along with the unlocking of the door locks, such that the electric module 101 produces and conducts the actuation power to the light module 111 and the audio module 112, and the light module 111 emits a warning light while the audio module 112 emits a warning sound. When the door locks enter a locked state, the interlocking devices 102 are stopped accordingly to stop conducting the actuation power.

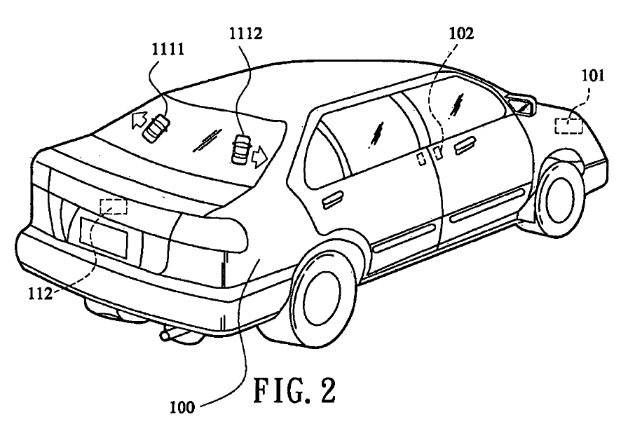

Referring to FIG. 2 and FIG. 1 together, FIG. 2 is an arrangement view of devices according to the first embodiment of the present invention. In this embodiment, the light module 111 is designed to warning lamps with patterns, and is disposed at the rear end of the vehicle 100 at the position corresponding to the door locks, and includes a left warning light 1111 and a right warning light 1112. The interlocking devices 102 are respectively disposed in each door in combination with the door locks (not shown), and are electrically connected to the left warning light 1111, the right warning light 1112, and the electric module 101. The electric module 101 is disposed at the front end of the vehicle 100 for actuating the vehicle 100. The audio module 112 can be disposed at any position of the vehicle 100. In this embodiment, the audio module 112 is disposed at the rear end of the vehicle 100 and is connected to the interlocking devices 102.

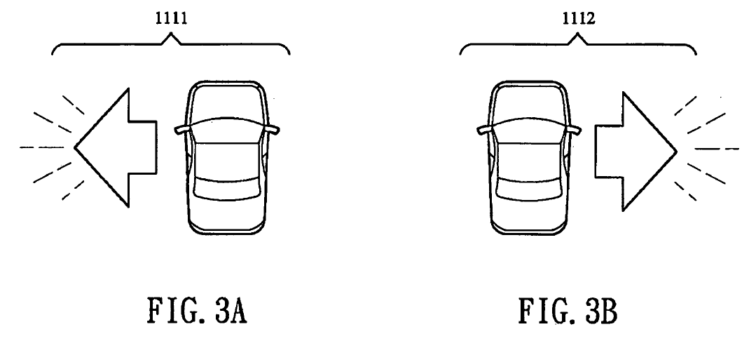

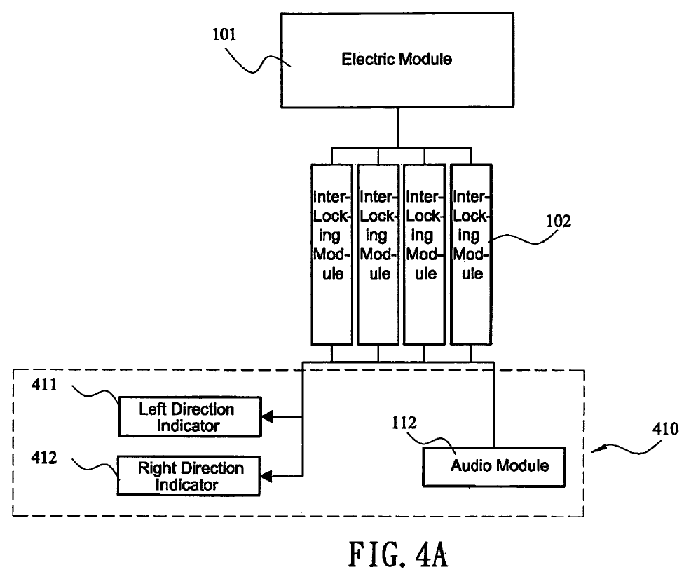

Referring to FIGS. 3A, 3B and FIG. 2 together, FIG. 3A and FIG. 3B are schematic views of the actuation of the light module. For example, when a door lock at the left side of the vehicle 100 is unlocked, the interlocking device 102 in the left door is actuated, and the left warning light 1111 emits the warning light. Otherwise, when a door lock at the right side of the vehicle 100 is unlocked, the interlocking device 102 in the right door is actuated, and the right warning light 1112 emits the warning light. However, no matter the left warning light 1111 or the right warning light 1112 emits the warning light, the audio module 112 also emits the warning sound at the same time. Moreover, the left warning light 1111 and the right warning light 1112 can be designed to be actuated simultaneously with the audio module 112 when one of the interlocking devices 102 is actuated.

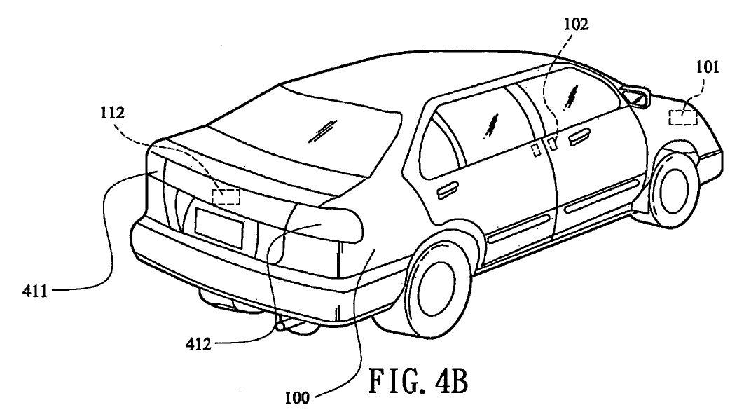

Referring to FIGS. 4A and 4B together, a schematic view of the system and an arrangement view of devices according to a second embodiment of the present invention are shown. The light module 111 in the warning device A 110 is directly replaced by the left and right direction indicators (411, 412) of the vehicle 100 to form a warning device B 410. For example, when the left interlocking device 102 is actuated, the left direction indicator 411 emits the warning light. Otherwise, when the right interlocking device 102 is actuated, the right direction indicator 412 emits the warning light. Alternatively, the left and right direction indicators (411, 412) can be actuated simultaneously when the interlocking devices 102 in any door are actuated. Definitely, the audio module 112 also emits the warning sound when the direction indicators (411, 412) send the warning light.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A car door opening early-warning system, adapted to a vehicle having a plurality of door locks and an electric module that is used to generate an actuation power, comprising:
a plurality of interlocking devices, disposed on the door locks and connected to the electric module, when any of the door locks is in an unlocked state, the corresponding interlocking device being actuated and conducting the actuation power; and
at least one warning device, disposed in the vehicle and connected to the interlocking devices, for sending a warning signal when receiving the actuation power.

2. The early-warning system as claimed in claim 1, wherein the warning device is a light module, and the warning signal is a warning light emitted by the light module after receiving the actuation power.

3. The early-warning system as claimed in claim 1, wherein the warning device is an audio module, and the warning signal is a warning sound emitted by the audio module when receiving the actuation power.

4. The early-warning system as claimed in claim 2, wherein the light module is a plurality of direction indicators of the vehicle.
